(19) United States
(12) Patent Application Publication
(10) Pub. No.: US 2026/0177099 A1
(43) Pub. Date: Jun. 25, 2026

(54) POSITION ADJUSTMENT MECHANISM AND POSITION ADJUSTMENT MEMBER

(71) Applicant: HI-LEX Corporation, Hyogo (JP)

(72) Inventors: Atsushi NISHIMURA, Hyogo (JP); Takuma IMAGAWA, Hyogo (JP); Masataka KISHIGUCHI, Hyogo (JP)

(73) Assignee: HI-LEX Corporation, Hyogo (JP)

(21) Appl. No.: 18/854,976

(22) PCT Filed: Apr. 18, 2023
(86) PCT No.: PCT/JP2023/015404

§ 371 Date: Oct. 8, 2024

(30) Foreign Application Priority Data
Apr. 18, 2022 (JP) 2022-068209
Mar. 24, 2023 (JP) 2023-048089

(51) Int. Cl. F16C 1/22

(52) U.S. Cl. CPC F16C 1/223

(57) ABSTRACT

A position adjustment mechanism includes: an engaging section that is provided at an end section of an inner cable and includes a screw section; and a position adjustment section to which the end section of the inner cable is connected and which is attached or fixed to a connection object. The position adjustment section includes an engaged section shaved by the screw section and engaged with the screw section by relative rotation of the engaging section and the position adjustment section.

### TECHNICAL FIELD

The present invention relates to a position adjustment mechanism and a position adjustment member.

### BACKGROUND ART

In a vehicle or the like to which a control cable is attached, the control cable is routed in a predetermined routing path and transmits an operation force applied to one side to the other side. The control cable includes an inner cable of which one end section and the other end section are attached to a predetermined portion of an attachment object, and an outer casing into which the inner cable is inserted and which guides the inner cable in a predetermined routing path.

When the one end section and/or the other end section of the inner cable are attached to the predetermined portion of the attachment object, a free movement length, which is a length that the inner cable protrudes from the outer casing, differs between control cables attached to the attachment object due to, for example, a bending manner of the outer casing that is routed in the predetermined routing path or a dimensional error of a component. This requires adjustment of an assembly position of the end section of the inner cable. In the same manner, there may be a case where adjustment of the assembly position of the end section of the outer casing is required.

For example, Patent Literature (hereinafter, referred to as PTL) 1 discloses an adjustment device that adjusts an attachment position of a control cable having a function of preventing the control cable from loosening. The adjustment device includes: a rod-shaped coupled body provided at one end of an inner cable; a coupling section in which the coupled body is disposed to be movable; and a lock body that locks the coupled body. The lock body holds the coupled body at a predetermined position with respect to the coupling section by being pushed in a direction perpendicular to an axis of the coupled body in a state in which the coupled body is disposed in a disposition section which is a cavity provided in the coupling section.

Further, PTL 2 discloses an adjustment mechanism for adjusting an attachment position of a control cable having a function of preventing the miniaturized control cable from loosening. In this length adjustment mechanism, a through-hole guiding the cable in an advanceable and retractable manner is provided in a stopper provided at a leading end of the cable, and a clamp plate at a slide hole orthogonal to this through-hole and a screw configured to press the clamp plate against the cable by threadedly engaging with the screw plate are further provided. Thus, by moving the stopper with respect to the cable and press the clamp plate against the cable by rotating the screw when the stopper is disposed in the desired position, it is possible to change the position of the stopper and to perform length adjustment of the cable.

### CITATION LIST

### Patent Literature

PTL 1
Japanese Patent Application Laid-Open No. 2014-145431
PTL 2
Japanese Utility Model Unexamined Publication No. 5-79034

### SUMMARY OF INVENTION

### Technical Problem

In a case of the structure such as the adjustment device in PTL 1, the coupling section needs to have a space for housing a lock body fitted from the outside of the coupled body in addition to a space into which the coupled body enters, and thus, the size of the device increases. When the device increases in size, there may be cases where it is impossible to provide an adjustment device depending on a place where position adjustment is necessary.

Further, regarding the length adjustment mechanism in PTL 2, miniaturization is possible, but the screw possibly loosens due to vibration or the like and the position of the stopper is possibly shifted.

An object of the present invention is to provide a position adjustment mechanism and a position adjustment member that are capable of being miniaturized and that prevent loosening due to an external factor such as vibration.

### Solution to Problem

A position adjustment mechanism of the present invention includes: an engaging section that is provided at an end section of an inner cable and includes a screw section; and a position adjustment section to which the end section of the inner cable is connected and which is attached or fixed to a connection object, in which the position adjustment section includes an engaged section shaved by the screw section and engaged with the screw section by relative rotation of the engaging section and the position adjustment section.

Further, a position adjustment mechanism of the present invention includes: an engaging section that is provided at an end section of an outer casing and includes a screw section; and a position adjustment section that is connected to the engaging section and is provided to be capable of adjusting a relative position of the outer casing with respect to a connection object to which the end section of the outer casing is connected, in which the position adjustment section includes an engaged section shaved by the screw section and engaged with the screw section by relative rotation of the engaging section and the position adjustment section.

Furthermore, a position adjustment member of the present invention is a position adjustment member to which an end section of an outer casing including an engaging section including a screw section or an end section of an inner cable including an engaging section including a screw section is connected and which is attached or fixed to a connection object, the position adjustment member including: an engaged section that is engaged with the screw section by being shaved by the screw section by relative rotation of the engaging section and the position adjustment.member

### Advantageous Effects of Invention

According to the position adjustment mechanism and the position adjustment member of the present invention, it is possible to reduce the size of the position adjustment mechanism and the position adjustment member, and it is possible to suppress loosening due to an external factor such as vibration.

### BRIEF DESCRIPTION OF DRAWINGS

FIG. 1 is a schematic diagram illustrating a cable operation device including a position adjustment mechanism according to an embodiment of the present invention;

FIG. 2 is a perspective view of the position adjustment mechanism in an embodiment of the present invention;

FIG. 3 is an exploded perspective view of the position adjustment mechanism illustrated in FIG. 2 in a state before assembly;

FIG. 4 is a longitudinal cross-sectional view of the position adjustment mechanism illustrated in FIG. 2 taken along an axial direction;

FIG. 5 is a longitudinal cross-sectional view of a state before an engaging section is inserted into the position adjustment section;

FIG. 6 is a diagram for describing the position adjustment in the position adjustment mechanism in which the engaging section moves in the axial direction from the state illustrated in FIG. 4;

FIG. 7 is a perspective view of a position adjustment mechanism in a variation;

FIG. 8 is a longitudinal cross-sectional view taken along the axial direction in a state in which the position adjustment mechanism illustrated in FIG. 7 is assembled;

FIG. 9 is an exploded perspective view of a state before a position adjustment mechanism of a second embodiment is assembled;

FIG. 10 is a longitudinal cross-sectional view of the position adjustment mechanism of the second embodiment in a state before the engaging section is inserted into a position adjustment section;

FIG. 11 is a longitudinal cross-sectional view of the position adjustment mechanism of the second embodiment in a state in which the engaging section is inserted into the position adjustment section;

FIG. 12 is a perspective view of the position adjustment mechanism of a third embodiment;

FIG. 13 is a longitudinal cross-sectional view of the position adjustment mechanism illustrated in FIG. 12 taken along the axial direction;

FIG. 14 is a perspective view of a position adjustment section of a position adjustment mechanism in a variation;

FIG. 15 is an exploded perspective view of a position adjustment mechanism of a fourth embodiment;

FIG. 16 is a perspective view of a state in which a fitting member is engaged with a screw section of an engaging section from a state illustrated in FIG. 15; and

FIG. 17 is a perspective view of a state in which the engaging section and an engaged body are connected to each other in the position adjustment mechanism of the fourth embodiment.

### DESCRIPTION OF EMBODIMENTS

Hereinafter, a position adjustment mechanism and a position adjustment member in an embodiment of the present invention will be described with reference to the accompanying drawings. Note that, the embodiments described below are merely examples, and the position adjustment mechanism and the position adjustment member of the present invention are not limited to the embodiments described below.

Herein, the phrase “perpendicular to A” and similar phrases do not only refer to a direction completely perpendicular to A, but also refer to a direction approximately perpendicular to A. Further, herein, the phrase “parallel to B” and similar phrases do not only refer to a direction completely parallel to B, but also refer to a direction approximately parallel to B. Moreover, herein, the term “C-shape” and similar terms do not refer only to a complete C-shape, but also refer to a shape that visually resembles a C-shape (approximately C-shape).

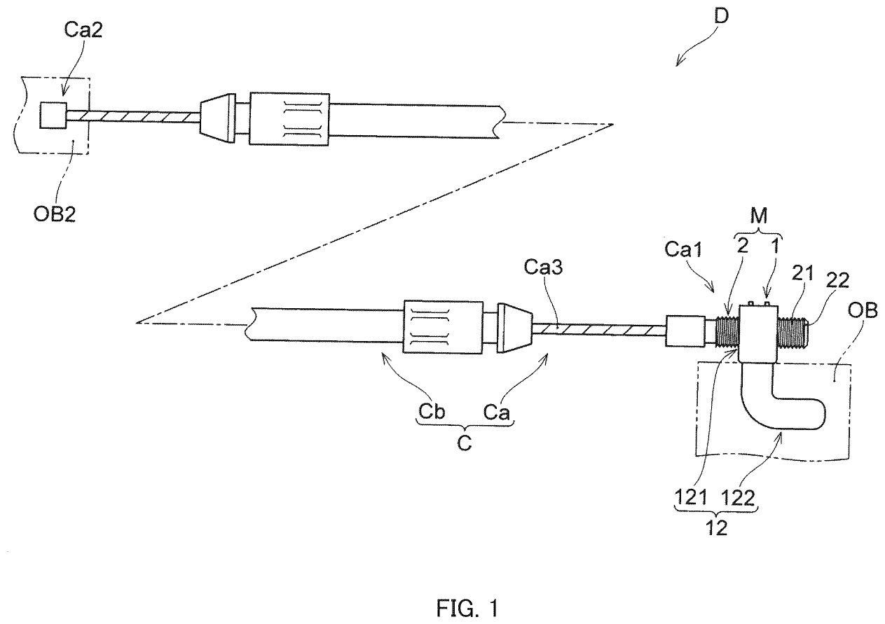

As illustrated in FIGS. 1 to 3, position adjustment mechanism M of the present embodiment includes: engaging section 2 provided at end section Ca1 of inner cable Ca and including screw section 21; and position adjustment section 1 to which end section Ca1 of inner cable Ca is attached or fixed and which is connected to connection object OB (see FIG. 1).

Position adjustment mechanism M adjusts the assembly position between position adjustment section 1 and end section Ca1 of inner cable Ca in the axial direction. This enables adjusting the position of end section Ca1 of inner cable Ca with respect to connection object OB, or adjusting a free movement length, which is a length that inner cable Ca protrudes from outer casing Cb. In the present specification, the term “axial direction” refers to a direction in which an axial center of inner cable Ca extends (the direction in which the axial core of inner cable Ca extends in the predetermined portion). In the present embodiment, the axial direction coincides with the axial center of engaging section 2, which is substantially cylindrical and linearly extends on the extension line of the axial center of cable main body Ca3 of inner cable Ca in end section Ca1 of inner cable Ca.

As long as position adjustment mechanism M is capable of adjusting the position of end section Ca1 of inner cable Ca in the axial direction with respect to position adjustment section 1, the application object of position adjustment mechanism M is not particularly limited. Position adjustment mechanism M is provided, for example, in cable operation device D (see FIG. 1) that operates inner cable Ca. Specifically, cable operation device D including position adjustment mechanism M can be used as a control cable operation device applied to a lock mechanism for an opening/closing object such as a hood, trunk, fuel lid of a vehicle, a seat lock mechanism for locking a state of inclination of a seat, and the like.

In the present embodiment, cable operation device D includes control cable C including inner cable Ca and outer casing Cb as illustrated in FIG. 1. Cable operation device D is provided at an attachment object such as a vehicle, and control cable C is routed to the attachment object through a predetermined routing path. In cable operation device D in the present embodiment, one end section Ca1 of inner cable Ca is connected to connection object OB, and the other end section Ca2 of inner cable Ca is connected to second connection object OB2. One of connection object OB and second connection object OB2 becomes an operating section that operates inner cable Ca, and the other of connection object OB and second connection object OB2 becomes an operated section operated through inner cable Ca. Thus, the operation force is transmitted from one end section Ca1 of inner cable Ca to the side of the other end section Ca2 or from the other end section Ca2 of inner cable Ca to the side of one end section Ca1.

Note that, the attachment object of cable operation device D (position adjustment mechanism M) is not limited to a vehicle, and the attachment object of cable operation device D (position adjustment mechanism M) can be applied to any structure for transmitting the operation force by inner cable Ca. Note that, connection object OB is a predetermined portion in the attachment object of cable operation device D (position adjustment mechanism M) to which to which one end section Ca1 of inner cable Ca is connected, and is appropriately changed according to the application to which position adjustment mechanism M is applied. Similarly, second connection object OB2 is a predetermined portion in the attachment object of cable operation device D (position adjustment mechanism M) to which the other end section Ca2 of inner cable Ca is connected, and is appropriately changed according to the application to which position adjustment mechanism M is applied.

Inner cable Ca is inserted into outer casing Cb and transmits the operation force between one end section Ca1 and the other end section Ca2 of inner cable Ca. As illustrated in FIG. 1, inner cable Ca includes one end section Ca1, the other end section Ca2, and cable main body Ca3 that extends between one end section Ca1 and the other end section Ca2. The structure of inner cable Ca is not particularly limited, and may be, for example, an inner cable of a well-known control cable.

One end section Ca1 of inner cable Ca includes engaging section 2 including screw section 21 as illustrated in FIGS. 1 to 3. Engaging section 2 engages with position adjustment section 1 to be capable of adjusting the position of one end section Ca1 of inner cable Ca in the axial direction. Engaging section 2 includes screw section 21 on the outer periphery, and is configured to threadedly engage with position adjustment section 1 in a manner to be described in detail later. As long as engaging section 2 can engage with position adjustment section 1 so as to be capable of adjusting the position in the axial direction of one end section Ca1 of inner cable Ca, the shape and structure of engaging section 2 are not particularly limited. In the present embodiment, engaging section 2 is formed in a substantially cylindrical shape having screw section 21 formed as a male screw on the outer periphery, and includes taper section 22 (see FIG. 4) whose tip is gradually tapered at the leading end of engaging section 2. Note that, cable main body Ca3 of inner cable Ca may be integrally fixed to end section Ca1 (end section member including engaging section 2) by casting or the like, or may be rotatably attached to end section Ca1 (end section member including engaging section 2) around the axis. Further, the end section including the engaging section may be provided at both ends of the inner cable, and in this case, the end section is configured to threadedly engage with the position adjustment section such that a position in the axial direction at both ends of the inner cable can be adjusted.

Outer casing Cb is a member having a tubular shape and flexibility into which inner cable Ca is inserted. Outer casing Cb includes an inner space in which inner cable Ca slides. When inner cable Ca is operated, inner cable Ca slides within the inner space of outer casing Cb. Outer casing Cb is routed to the attachment object such as a vehicle through a predetermined routing path, and both end sections of outer casing Cb are fixed to predetermined portions of the attachment object such as a vehicle.

Position adjustment section 1, the details of which will be described later, is a section for adjusting the position of end section Ca1 of inner cable Ca in the axial direction by engaging with engaging section 2 and by engaging section 2 relatively moving in the axial direction with respect to position adjustment section 1 or by position adjustment section 1 relatively moving with respect to position adjustment section 1. By engaging position adjustment section 1 with engaging section 2, end section Ca1 of inner cable Ca is connected to position adjustment section 1 through engaging section 2. Further, position adjustment section 1 is attached to or fixed to connection object OB. In the present embodiment, position adjustment section 1 is exemplified as a position adjustment member configured to be detachable from connection object OB. However, position adjustment section 1 may be integrally molded with connection object OB, or may be integrally provided with connection object OB by a known fixing means such as welding.

As illustrated in FIGS. 4 to 6, position adjustment section 1 includes engaged section E that is engaged with screw section 21 by being shaved by screw 21 by engaging section 2 and position adjustment 1 rotating relatively to each other. Engaged section E is provided at engaged body 11 housed in housing member 12 described later in the present embodiment, but the engaged section may be integrally provided with a member corresponding to the housing member.

Engaged section E is a portion that is engaged with screw section 21 of engaging section 2. Engaged section E is engaged with screw section 21 in a state where a part of engaged section is shaved by screw section 21 and the screw groove is cut by screw section 21 by the relative rotation of engaging section 2 and position adjustment section 1. Thus, the position of end section Ca1 of inner cable Ca in the axial direction is adjusted depending on the relative rotation direction and the rotation amount between engaging section 2 and position adjustment section 1, and end section Ca1 of inner cable Ca is restricted from relatively moving in the axial direction with respect to position adjustment section 1. The relative rotation between engaging section 2 and position adjustment section 1 is relative rotation about the axis of inner cable Ca. The relative rotation between engaging section 2 and position adjustment section 1 may be relative rotation caused by engaging section 2 rotating with respect to position adjustment section 1, relative rotation caused by position adjustment section 1 rotating with respect to engaging section 2, or relative rotation caused by both engaging section 2 and position adjustment section 1 rotating.

Engaged section E is constituted by a material which is shaved by screw section 21 and can form, on engaged section E, a screw groove corresponding to the screw thread of screw section 21 when screw section 21 and engaged section E relatively rotate. Further, the material constituting engaged section E has a predetermined rigidity such that, when a force in the axial direction is applied to end section Ca1 of inner cable Ca, engagement between engaged section E and the screw thread of screw section 21 can be maintained (is not easily deformed or damaged). The material constituting engaged section E can have any shape as long as the material can be shaved by screw section 21 and has a predetermined rigidity capable of maintaining engagement with screw section 21 as described above. In the present embodiment, engaged section E is constituted by a resin having the above-described characteristic, for example, nylon or the like.

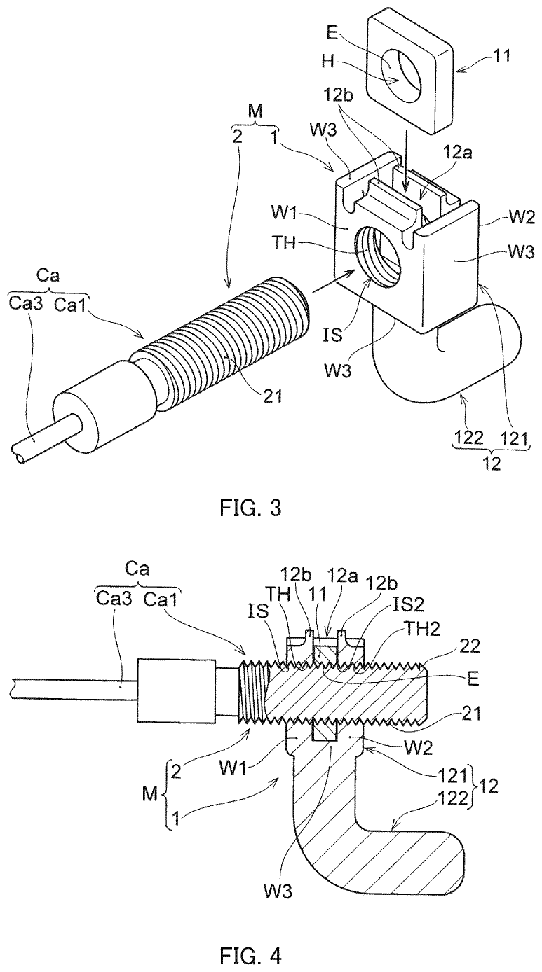

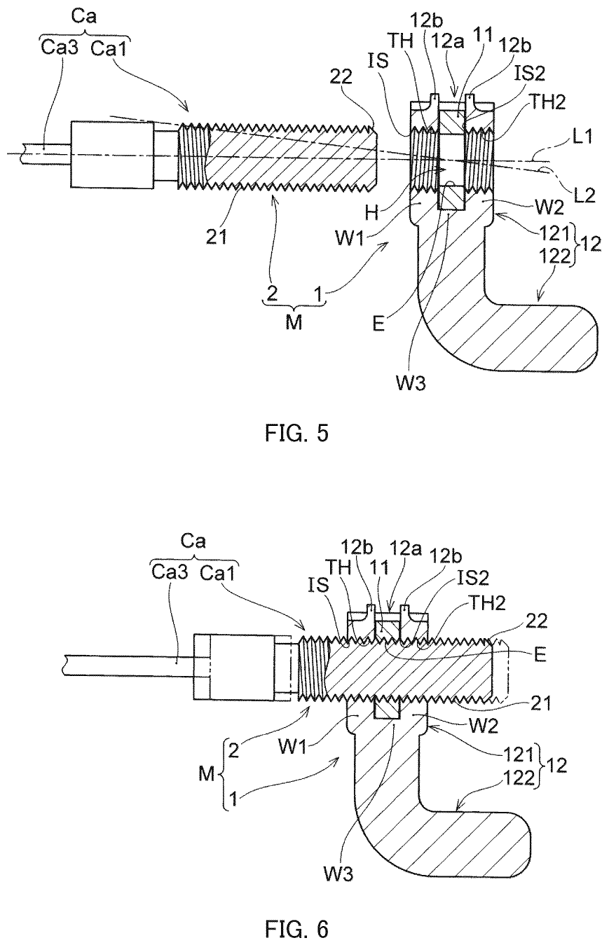

In the present embodiment, before a part of engaging section 2 is shaved by screw section 21 (see FIGS. 3 and 5), engaged section E is constituted by an opening portion having a through-hole on which a screw groove is not formed, specifically, constituted by an inner surface of the penetrated portion defining through-hole H that is provided in engaged body 11 to be described later, extends in the axial direction, and has a substantially cylindrical shape. Further, in a state in which a part of engaged section E is shaved by screw section 21 of engaging section 2 (see FIGS. 4 and 6), engaged section E becomes a portion which faces the outer periphery of screw section 21 and in which a screw groove is formed by screw section 21. In the present embodiment, in a state before a part of engaged section E is shaved by screw section 21 (see FIG. 5), the inner diameter of the opening portion including through-hole H that constitutes engaged section E is set to be smaller than the outer diameter of screw section 21 of engaging section 2 (outer diameter of the top of the screw thread), and is preferably set to be smaller than the outer diameter of the top of screw section 21 and larger than the outer diameter at the bottom of the valley of screw section 21.

When engaging section 2 and position adjustment section 1 relatively rotate while a part of screw section 21 of engaging section 2 is in contact with a portion constituting engaged section E, the portion of screw section 21 constituting engaged section E is shaved into a screw groove by screw section 21. Thus, engaged section E and screw section 21 engage with each other. In a case where further position adjustment of end section Ca1 of inner cable Ca is necessary in this state, end section Ca1 of inner cable Ca moves around the axis with respect to position adjustment section 1 by relatively rotating position adjustment section 1 and engaging section 2 in the predetermined direction in the axial direction, as illustrated by the two-dot chain line in FIG. 6. Further, end section Ca1 of inner cable Ca is held at a predetermined position in the axial direction by engagement between engaged section E and screw section 21 after the movement. This makes it possible to adjust the position of end section Ca1 of inner cable Ca.

In the present embodiment, position adjustment mechanism M (position adjustment section 1) can perform the position adjustment of end section Ca1 of inner cable Ca by relatively rotating engaging section 2 and position adjustment section 1 to shave a part of engaged section E, and moving engaging section 2 in the axial direction with respect to position adjustment section 1 from the state illustrated by the solid line to the state illustrated by the two-dot chain line in FIG. 6. Accordingly, in the present embodiment, it is not necessary to provide a space which is large in the radial direction of inner cable Ca as in the lock body that is attached and detached in the radial direction of the inner cable as disclosed in PTL 1. This eliminates the need of increasing the size of position adjustment mechanism M or position adjustment section 1 in the radial direction of inner cable Ca, thus miniaturizing position adjustment mechanism M or position adjustment section 1. Thus, position adjustment mechanism M and position adjustment section 1 can be applied to an attachment object for which an installation space or a workspace cannot be sufficiently secured in its surroundings. Further, engaged section E is engaged with screw section 21 in a state of being in close contact with screw section 21 on both sides in the axial direction (preferably, in the radial direction in addition to on both sides in the axial direction) by being shaved by screw section 21. Thus, a gap is less likely to be generated between screw section 21 and engaged section E. Accordingly, as illustrated in FIGS. 4 and 6, the friction increases due to the close contact between screw section 21 and engaged section E, which suppresses loosening of screw section 21 with respect to engaged section E caused by an external factor such as vibration of an attachment object such as a vehicle or the operation of inner cable Ca.

In the present embodiment, position adjustment section 1 includes engaged body 11 in which engaged section E is provided and housing member 12 that houses engaged body 11, as illustrated in FIGS. 3 to 6.

Engaged body 11 is a member including engaged section E, and is housed in housing member 12. Here, “housing” refers to a state in which engaged body 11 is located on the inside of housing member 12 at least partially, and does not necessarily mean that the whole of engaged body 11 is completely covered with housing member 12, and a part of engaged body 11 may protrude to the outside of housing member 12.

The shape and structure of engaged body 11 are not particularly limited as long as engaged body 11 includes engaged section E and can be housed in housing member 12. In the present embodiment, engaged body 11 is formed in a plate shape in which through-hole H is formed in a central portion thereof. Engaged body 11 includes one surface and the other surface on the side opposite to the one surface in the axial direction. Through-hole H penetrates in the axial direction between one surface and the other surface. Engaged section E is provided in engaged body 11, and engaged section E and screw section 21 engage with each other by the inner surface of the opening portion in which through-hole H is formed being shaved by screw section 21 of engaging section 2. Note that, in a state before engaging section 2 is inserted, a screw groove is not formed on the inner surface of the opening portion formed by through-hole H of engaged body 11, as illustrated in FIGS. 3 and 5

In the present embodiment, when engaging section 2 including screw section 21 is screwed into engaged section E of engaged body 11, engaged body 11 is housed in housing member 12 in a state in which co-rotation of engaged body 11 with engaging section 2 is suppressed. Specifically, engaged body 11 is engaged with housing member 12 in a direction around the axis, so that the rotation of engaged body 11 with respect to housing member 12 is suppressed, and thus the co-rotation of engaged body 11 with engaging section 2 is suppressed. In the present embodiment, by causing engaged body 11 having a substantially rectangular shape to engage with the internal surface of housing member 12 having an internal space corresponding to the shape of engaged body 11 in a direction around the axis, rotation of engaged body 11 around the axis with respect to housing member 12 is suppressed.

Housing member 12 houses engaged body 11. In the present embodiment, housing member 12 houses engaged body 11 in a state in which relative rotation of engaged body 11 with respect to housing member 12 in a direction around the axis is suppressed and in a state in which movement in the axial direction with respect to housing member 12 is suppressed.

The shape and structure of housing member 12 are not particularly limited as long as housing member 12 can house engaged body 11. In the present embodiment, housing member 12 includes housing section 121 that houses engaged body 11, and attachment section 122 that is attached to connection object OB, as illustrated in FIGS. 1 to 3. Further, housing member 12 (housing section 121) includes insertion section IS provided at a position where insertion engaging section 2 can be guided to engaged section E.

Attachment section 122 is a portion of housing member 12 and is attached to connection object OB. After housing member 12 is attached to connection object OB through attachment section 122, the position in the axial direction between engaging section 2 and position adjustment section 1 is adjusted, thereby adjusting the position of end section Ca1 of inner cable Ca with respect to connection object OB. As long as attachment section 122 can be attached to connection object OB, the shape and structure of attachment section 122 are not particularly limited.

Housing section 121 houses engaged body 11. In the present embodiment, housing section 121 houses engaged body 11 such that rotation of engaged body 11 around the axis with respect to housing section 121 is suppressed and such that movement in the axial direction is suppressed. As long as housing section 121 is configured to house engaged body 11, the shape and structure of housing section 121 are not particularly limited. In the present embodiment, housing section 121 includes a wall section that defines an internal space having a substantially rectangular shape to be capable of housing engaged body 11 having a substantially rectangular shape. Specifically, as illustrated in FIGS. 3 and 4, housing section 121 includes first wall section W1 provided on one side in the axial direction, and second wall section W2 facing first wall section W1 with a predetermined separation distance in the axial direction. Further, housing section 121 includes a plurality of (three in the present embodiment) side walls W3 (see FIG. 3) that connect first wall section W1 and second wall section W2.

Insertion section IS guides engaging section 2 toward engaged section E so that engaging section 2 can engage with engaged section E provided inside housing section 121 from the outside of housing section 121. In the present embodiment, insertion section IS includes an insertion hole that penetrates through first wall section W1 in the axial direction. Insertion section IS is formed with a size into which engaging section 2 is insertable. Further, as illustrated in FIG. 5, insertion section IS is provided in a position where through-hole H formed in engaged body 11 and the insertion hole of insertion section IS are coaxial with each other in a state where engaged body 11 is housed in housing section 121. As described later, housing member screw section TH is provided on the inner surface of insertion section IS, but housing member screw section TH need not be provided.

Further, in the present embodiment, housing member 12 (housing section 121) includes second insertion section IS2 which is provided on the side opposite to insertion section IS with respect to engaged section E, and by which engaging section 2 penetrating engaged section E in the axial direction is guided. Second insertion section IS2 is provided so that engaging section 2 is guided from the position of engaged section E to the outside of housing section 121. In the present embodiment, second insertion section IS2 includes, in second wall section W2, an insertion hole which penetrates in the axial direction. Second insertion section IS2 is formed in a size into which engaging section 2 is insertable. Further, as illustrated in FIG. 5, second insertion section IS2 is provided in a position in which through-hole H formed in engaged body 11 and the insertion hole of second insertion section IS2 become coaxial in a state in which engaged body 11 is housed in housing section 121. Further, as illustrated in FIG. 5, second insertion section IS2 is provided in a position coaxial with insertion section (first insertion section) IS in a state where engaged body 11 is housed in housing section 121. Note that, housing member screw section TH2 is provided on the inner surface of second insertion section IS2 in advance, but housing member screw section TH2 need not be provided.

In the present embodiment, the separation distance between first wall section W1 and second wall section W2 in the axial direction is a length (the same or slightly smaller) corresponding to the thickness of engaged body 11, and thus, when engaged body 11 is housed in housing section 121, the movement of engaged body 11 in the axial direction with respect to housing member 12 is restricted in a state of being sandwiched between first wall section W1 and second wall section W2.

As illustrated in FIGS. 3 and 4, the plurality of side walls W3 extends substantially perpendicularly to first wall section W1 and second wall section W2, and separates the internal space of housing section 121 from the outside of housing section 121 in the radial direction of inner cable Ca, except for a portion of opening section 12a to be described later. Further, the plurality of side walls W3 prevents engaged body 11 from rotating around the axis with respect to housing member 12 by engaging with the outer peripheral surface of engaged body 11 around the axis.

Further, in the present embodiment, housing member 12 includes, as illustrated in FIG. 3, opening section 12a into which engaged body 11 can be inserted in a direction perpendicular to the axis of inner cable Ca. Opening section 12a is an opening section for assembling engaged body 11 to housing member 12 before the position adjustment of end section Ca1 of inner cable Ca is performed. Opening section 12a opens to connect the internal space of housing section 121 of housing member 12 and the outside of housing member 12 to each other.

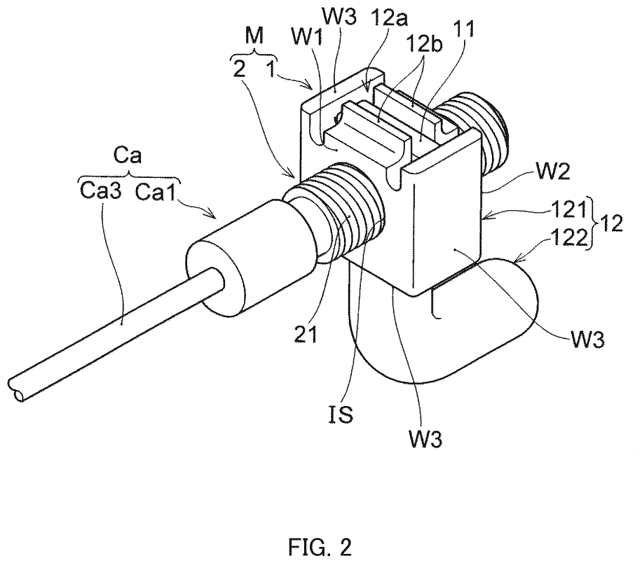

As illustrated in FIGS. 2 to 4, housing member 12 includes detachment prevention section 12b that is deformable such that the width of opening section 12a is reduced to a width, in a state where engaged body 11 is inserted into housing member 12 through opening section 12a, that prevents engaged body 11 from being detached from opening section 12a. In FIGS. 2 to 4, detachment prevention section 12b is illustrated in a state in which detachment prevention section 12b is not deformed, but after engaged body 11 is housed in housing member 12, detachment prevention section 12b is deformed, for example, by being bent or crimped so that the gap in opening section 12a becomes narrow. In a case where detachment prevention section 12b is provided, it is possible to prevent engaged body 11 from detaching from housing member 12 when engaging section 2 is screwed into engaged body 11 after engaged body 11 is assembled to housing member 12. Accordingly, the work of screwing engaging section 2 into engaged body 11 is facilitated. Note that, in the present embodiment, detachment prevention section 12b includes a pair of detachment prevention sections 12b that are spaced apart from each other in the axial direction, and prevents engaged body 11 from being detached from opening section 12a by deforming in a direction in which detachment prevention section 12b approach each other.

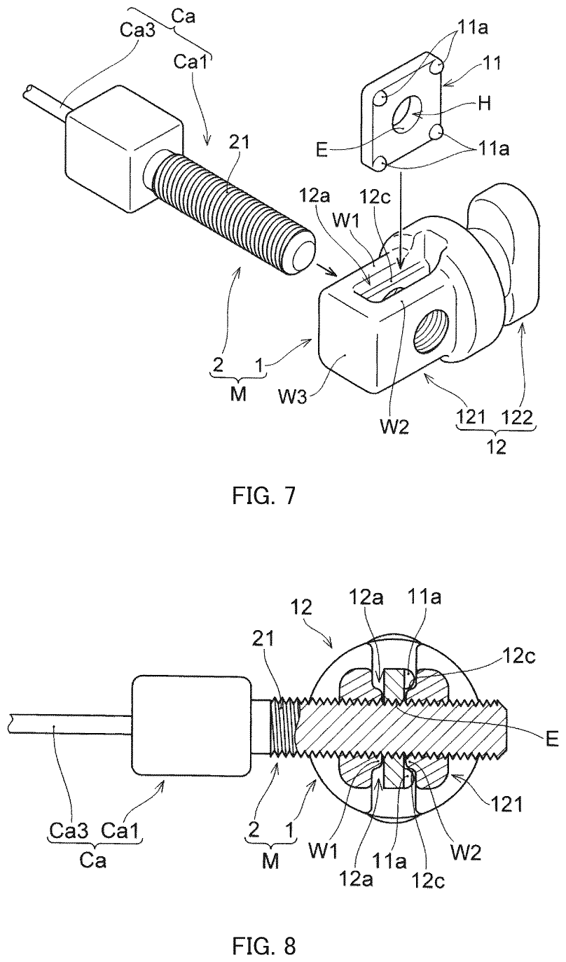

Further, as a variation, instead of providing detachment prevention section 12b to housing member 12, engaged body 11 may include restricting section 11a that prevents engaged body 11 from moving in a direction in which engaged body 11 is detached from opening section 12a, as illustrated in FIGS. 7 and 8. Restricting section 11a prevents engaged body 11 from being detached from housing member 12 in a state where engaged body 11 is housed in a predetermined position of housing member 12. As long as restricting section 11a can prevent engaged body 11 from moving in a direction in which engaged body is detached from opening section 12a, the shape and structure of restricting section 11a are not particularly limited. In the present embodiment, restricting section 11a is constituted by a protruding section configured to be engaged with a part of housing member 12 in the direction in which engaged body 11 is detached, as illustrated in FIGS. 7 and 8. In the present embodiment, the thickness of a portion of engaged body 11 at which restricting section 11a is not formed in the axial direction (for example, a portion around through-hole H of engaged body 11) corresponds to a thickness (the same or slightly thin) corresponding to the separation distance between first wall section W1 and second wall section W2 of housing section 121 of housing member 12. Further, the thickness of a portion in which restricting section 11a is provided in the axial direction is thicker than the separation distance between first wall section W1 and second wall section W2 of housing section 121 of housing member 12. In a case where engaged body 11 is inserted into housing section 121 through opening section 12a, engaged body 11 is press-fitted into the internal space of housing section 121. Specifically, by restricting section 11a and/or first wall section W1 and second wall section W2 being slightly elastically deformed, engaged body 11 is press-fitted into housing section 121. In a state where engaged body 11 is housed in housing section 121, restricting section 11a is held in a predetermined position in housing section 121 by being engaged with step-shaped portion 12c at which a space between first wall section W1 and second wall section W2 increases, in a direction vertical to the axial direction (see FIG. 8). This prevents engaged body 11 from being detached from housing section 121 before engaging section 2 is screwed into engaged body 11.

In the present embodiment, insertion section IS includes housing member screw section TH, formed to be engaged with screw section 21 of engaging section 2, as illustrated in FIGS. 3 to 6. In this case, when screw section 21 of engaging section 2 is screwed into engaged body 11, screw section 21 of engaging section 2 is guided by housing member screw section TH of insertion section IS, so that engaging section 2 can move in the axial direction in a stable posture. More specifically, by screw section 21 of engaging section 2 being guided by housing member screw section TH of insertion section IS, engaging section 2 can move in the axial direction in a state where the axial center of engaging section 2 coincides with the axial centers of the insertion hole in insertion section IS and through-hole H of engaged body 11 (see two-dot chain line L1 in FIG. 5). This prevents the insertion of engaging section 2 into engaged body 11 while engaging section 2 is inclined with respect to engaged body 11 (see two-dot chain line L2 in FIG. 5), and prevents engaged body 11 from being shaved at an abnormal angle. Further, this prevents the axial center of engaging section 2 from being inclined from a direction of two-dot chain line L1 to a direction of two-dot chain line L2 after engaging section 2 is inserted into engaged body 11 in a state in which the axial center of engaging section 2 coincides with the axial centers of the insertion hole of insertion section IS and through-hole H of engaged body 11 along tow-dot chain line L1 in FIG. 5. Accordingly, deformation in which engaging section 2 is inclined in the direction of two-dot chain line L2 or the like and through-hole H of engaged body 11 is widened is prevented. Thus, loosening of the engagement between screw section 21 of engaging section 2 and engaged section E caused by the deformation of the engaged section E of engaged body 11 is prevented. Further, in a case where housing member screw section TH2 is provided also in second insertion section IS2 in addition to insertion section IS, inclination of engaging section 2 is further prevented, thereby further preventing loosening of the engagement between screw section 21 of engaging section 2 and engaged section E.

As described above, in the present embodiment, as illustrated in FIGS. 4 and 5, screw section 21 and housing member screw section TH of insertion section IS engage with each other, and screw section 21 and the screw groove of engaged section E engage with each other. As described above, the engagement between screw section 21 and engaged section E functions as follows: the surface of the screw groove of engaged section E in a state being shaved by screw section 21 and the surface of the male screw of screw section 21 are in close contact with each other substantially without a gap therebetween, and a large frictional force is generated by the repulsive force applied to screw section 21 by engaged section E, thereby making it difficult for screw section 21 to loosen. Further, the engagement between screw section 21 and housing member screw section TH of insertion section IS has a function of guiding the axis of engaging section 2 including screw section 21 without inclination. By combining the engagement between screw section 21 and housing member screw section TH of insertion section IS and the engagement between screw section 21 and the screw groove of engaged section E as described above, it is possible to suppress the loosening of the engagement between screw section 21 of engaging section 2 and housing member screw section TH of insertion section IS and the loosening from engaged section E resulting from the damage of engaged section E, which is relatively easy to deform and crumble, thereby enhancing the effect of preventing screw section 21 from loosen.

Further, in the present embodiment, as illustrated in FIGS. 4 and 6, screw section 21 of engaging section 2 engages with both housing member screw section TH of first wall section W1 and housing member screw section TH2 of second wall section W2 in a state where engaged body 11 is, in housing section 12, interposed between first wall section W1 and second wall section W2 in the axial direction. In the present embodiment, the force by the engagement by screw section 21 shaving engaged section E acts to prevent loosening between screw section 21 and housing member screw section TH of first wall section W1, and loosening between screw section 21 and housing member screw section TH2 of second wall section W2. This action of preventing loosening continues even when the position of engaging section 2 with respect to position adjustment section 1 changes when the position of end section Ca1 of inner cable Ca is adjusted from the solid line of FIG. 6 to the two-dot chain line. Accordingly, engaging section 2 can exhibit the function of preventing loosening at any position in the axial direction.

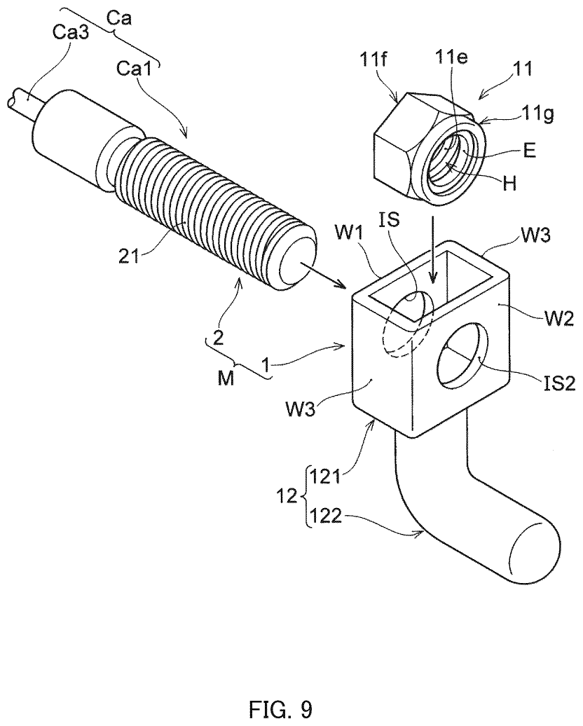

Next, a position adjustment mechanism in a second embodiment will be described with reference to FIGS. 9 to 11. As illustrated in FIG. 9, position adjustment mechanism M of the present embodiment includes: engaging section 2 provided at end section Ca1 of inner cable Ca and including screw section 21; and position adjustment section 1 to which end section Ca1 of inner cable Ca is connected and which is attached or fixed to connection object OB (see FIG. 1).

Note that, a detailed description of configurations of engaging section 2 and position adjustment section 1, and sections in which the configuration can be the same as that in the first embodiment are omitted, and a description will be made mainly of differences. All the matters described in the first embodiment with respect to engaging section 2 and position adjustment section 1 can be applied to position adjustment mechanism M in the second embodiment as far as the object of the present invention can be achieved, and the configuration of the present embodiment can be combined with the contents described in the first embodiment. The effects obtained by the configuration described in the first embodiment can also be obtained in the second embodiment as long as the second embodiment has the same configuration.

In the present embodiment, position adjustment section 1 includes engaged body 11 provided with engaged section E, and housing member 12 that houses engaged body 11, as illustrated in FIGS. 9 to 11. In the present embodiment, housing member 12 houses engaged body 11 in a state in which engaged body 11 is prevented from relatively rotating around the axis with respect to housing member 12, and in a state in which engaged body 11 is prevented from moving in the axial direction with respect to housing member 12.

In the present embodiment, housing section 121 of housing member 12 includes wall sections that define an internal space capable of housing engaged body 11 having a configuration described later. Specifically, as illustrated in FIG. 9, housing section 121 includes first wall section W1 provided on one side in the axial direction, and second wall section W2 facing first wall section W1 with a predetermined distance therebetween in the axial direction. Further, housing section 121 includes a plurality of side walls W3 that connect first wall section W1 and second wall section W2 to each other.

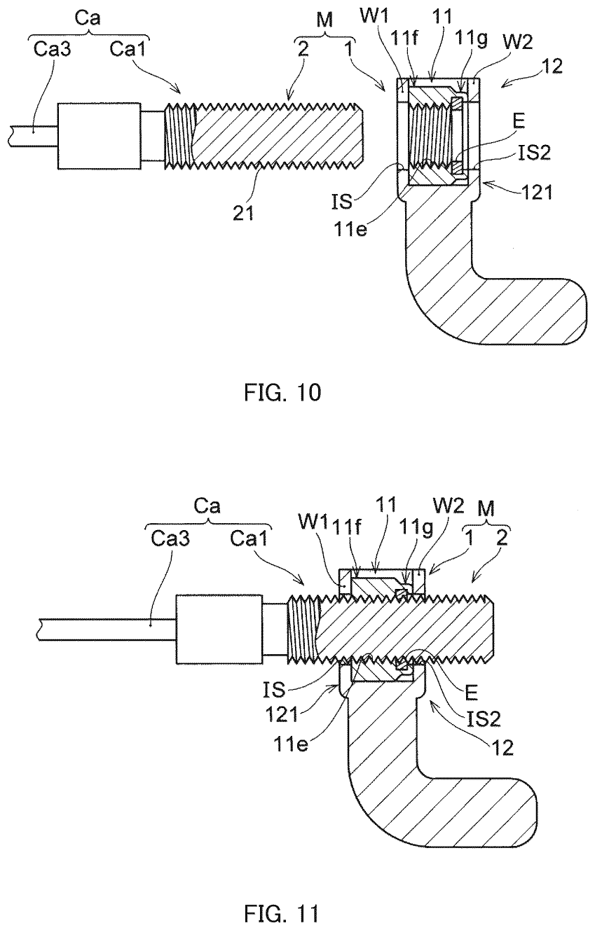

In the present embodiment, the separation distance between first wall section W1 and second wall section W2 in the axial direction corresponds (the same or slightly short) to a length of engaged body 11 in the axial direction, and thus, when engaged body 11 is housed in housing section 121, the movement of engaged body 11 in the axial direction with respect to housing member 12 is restricted in a state in which engaged body 11 is interposed between first wall section W1 and second wall section W2 (see FIGS. 10 and 11). A plurality of side walls W3 prevents engaged body 11 from rotating around the axis with respect to housing member 12 by engaging with the outer peripheral surface of engaged body 11 around the axis.

Note that a restricting section (not illustrated) that restricts movement of engaged body 11 in a direction of being detached from housing member 12 (upward direction in FIGS. 10 and 11) may be provided on the inner surface of housing section 121 (first wall section W1, second wall section W2, and side wall W3). This restricting section is provided on, for example, a part or all of inner surfaces of first wall section W1, second wall section W2, and side wall W3, and prevents the movement of engaged body 11 in a direction of being detached from housing member 12 by engaging with the outer surface of engaged body 11. Note that, the shape and structure of the restricting section are not particularly limited as long as the restricting section can restrict the movement in a direction in which engaged body 11 is detached from housing member 12. The restricting section may be, for example, a protruding section identical to the protruding section of engaged body 11 illustrated in FIG. 7. For example, restricting section serves as resistance at the time of the detachment of engaged body 11 by protruding from the inner surface of any one of first wall section W1, second wall section W2, and side wall W3 toward the inside and by engaging with the outer surface of engaged body 11, and thus, it is possible to prevent engaged body 11 from being detached.

Further, housing section 121 includes insertion section IS on one side (first wall section W1) in the axial direction, and second insertion section IS2 on the other side (second wall section W2) in the axial direction. Insertion section IS and second insertion section IS2 are formed in a size into which engaging section 2 is insertable. In the present embodiment, in contrast to the first embodiment, no housing member screw section is formed in insertion section IS and second insertion section IS2. In this case, engaging section 2 can be easily inserted into housing member 12, and the material for housing member 12 can be flexibly selected as described later. Note that, in the same manner as in the first embodiment, either or both of insertion section IS and second insertion section IS2 of housing member 12 may have a housing member screw section.

As in the first embodiment, position adjustment section 1 includes engaged section E (see FIGS. 10 and 11) that is engaged with screw section 21 by being shaved by screw section 21 by the relative rotation of engaging section 2 and position adjustment section 1, and thus, position adjustment mechanism M of the present embodiment can also obtain the same effects as those in the first embodiment. Engaged section E is engaged with screw section 21 in a state in which a part thereof is shaved by screw section 21 and then a screw groove is formed by the relative rotation of engaging section 2 and position adjustment section 1 (see FIG. 11). Thus, the position of end section Ca1 of inner cable Ca in the axial direction is adjusted according to the direction and the rotation amount of the relative rotation between engaging section 2 and position adjustment section 1, and end section Ca1 of inner cable Ca is restricted from relatively moving in the axial direction with respect to position adjustment section 1. The relative rotation between engaging section 2 and position adjustment section 1 may be relative rotation caused by engaging section 2 rotating with respect to position adjustment section 1, relative rotation caused by position adjustment section 1 rotating with respect to engaging section 2, or relative rotation caused by both engaging section 2 and position adjustment section 1 rotating.

In the present embodiment, the shape and structure of engaged body 11 are not particularly limited as long as engaged body 11 includes engaged section E and can be housed in housing member 12. In the present embodiment, engaged body 11 is a cylindrical body having through-hole H into which engaging section 2 is inserted, as illustrated in FIG. 9. More specifically, engaged body 11 has a nut-shaped square-column shape. Engaged body 11 includes first end section 11f (the left end in FIG. 10) on a side, in the axial direction, on which engaging section 2 is first inserted, and second end section 11g (the right end in FIG. 10) on a side, in the axial direction, opposite to first end section 11f. Note that, engaged body 11 may have a shape other than the nut shape, such as a quadrangular shape with a cross-section perpendicular to the axial direction. In the present embodiment, the outer surface of engaged body 11 is configured to engage with side wall W3 of housing member 12 in a direction around the axis, and rotation of engaged body 11 around the axis with respect to housing member 12 is restricted. Further, as illustrated in FIGS. 10 and 11, both ends of the axial direction of engaged body 11 are engaged with a wall (first wall section W1 and second wall section W2) of housing member 12, and relative movement of engaged body 11 in the axial direction with respect to housing member 12 is restricted.

As illustrated in FIGS. 9 to 11, engaged body 11 further includes engaged body screw section 11e provided to be engaged with screw section 21 of engaging section 2, in addition to engaged section E.

Engaged section E is a portion of engaged body 11 that is engaged with screw section 21 by being shaved by screw section 21 of engaging section 2 (see FIG. 11). In the present embodiment, engaged section E is constituted by a ring-shaped member provided on the inner surface of engaged body 11 which is a cylindrical body. In the present embodiment, engaged section E is made of an annular resin material. Engaged section E made of a ring-shaped resin material is formed as a separate body from the cylindrical portion of engaged body 11 and is fixed to the cylindrical portion. The material of engaged section E is not particularly limited as long as the material can be shaved by screw section 21 and has a predetermined rigidity such that the engagement with screw section 21 can be maintained as described above. In the present embodiment, engaged section E is made of a resin having the characteristic described above, such as nylon. In the present embodiment, the inner diameter of a portion made of a annular resin material constituting engaged section E is set to be smaller than the outer diameter (outer diameter of the top of the screw thread) of screw section 21 of engaging section 2 in a state before the portion is shaved by screw section 21 (see FIG. 10), and is preferably set to be smaller than the outer diameter of the top of screw section 21 and larger than the outer diameter at the bottom of the valley of screw section 21.

As illustrated in FIG. 11, engaged body screw section 11e is configured to threadedly engage with screw section 21 of engaging section 2. Engaged body screw section 11e is provided such that the axial center of engaged body screw section 11e is coaxial with the axial center of engaged section E. In the present embodiment, engaged body screw section 11e is provided on the inner surface of engaged body 11, which has a cylindrical shape. More specifically, engaged body screw section 11e is provided on the inner surface of engaged body 11 to be adjacent to engaged section E in the axial direction.

In the present embodiment, engaged body screw section 11e is constituted by a predetermined rigid material having a rigidity higher than the rigidity of engaged section E. In this case, even when a force is applied to inner cable Ca in the axial direction and a force such that engaging section 2 relatively moves with respect to engaged body 11 in the axial direction is applied, screw section 21 of engaging section 2 firmly engages with engaged body screw section 11e in the axial direction. Accordingly, the relative movement of engaging section 2 with respect to engaged body 11 in the axial direction is restricted. This makes it possible to prevent the screw thread and the screw groove formed in engaged section E that has been shaved, from being deformed and crushed due to the relative movement of engaging section 2 with respect to engaged body 11 in the axial direction. As described above, in the present embodiment, the rotation of engaging section 2 around the axis is restricted by engaged section E, and the movement of engaging section 2 in the axial direction is restricted by screw section 21 and engaged body screw section 11e threadedly engaging with each other. This makes it possible to restrict rotation of engaging section 2 around the axis and relative movement in the axial direction by only engaged body 11. In this case, it is not necessary to form a screw section (see housing member screw section TH of the first embodiment) in housing member 12, and thus it is not necessary to increase the strength of housing member 12 in consideration of a force in the axial direction applied to the screw section of housing member 12. For this reason, the material that constitutes housing member 12 is not limited, and housing member 12 can be formed of any material, thus increasing the degree of freedom in selecting the material that constitutes housing member 12.

The rigid material that constitutes engaged body screw section 11e is not particularly limited as long as the material has a rigidity higher than the rigidity of engaged section E and is capable of preventing engaging section 2 from relatively moving in the axial direction with respect to engaged body 11. In the present embodiment, engaged body screw section 11e is a female screw made of a metal material. Note that, engaged body screw section 11e may be made of a highly rigid and strong resin material whose rigidity is higher than the rigidity of engaged section E, such as a reinforced resin.

In engaged body 11, the position in the axial direction in which engaged section E is provided is not particularly limited. Engaged section E may be provided on the inner surface of engaged body 11 on the side of first end section 11f or may be provided in a central portion in the axial direction. In the present embodiment, engaged section E is provided on the inner surface of engaged body 11 on the side of second end section 11g. In this case, engaging section 2 first engages with engaged body screw section 11e, and then engages with engaged section E in a process in which engaging section 2 engages with engaged body 11. Accordingly, engaging section 2 threadedly engages with engaged body screw section 11e and is guided along engaged body screw section 11e, so that engaging section 2 moves toward engaged section E with the axial center of engaging section 2 coinciding with the axial center of engaged section E. Thus, it is possible to cause engaging section 2 to shave engaged section E in a state where engaged section 2 is accurately positioned with respect to engaged section E.

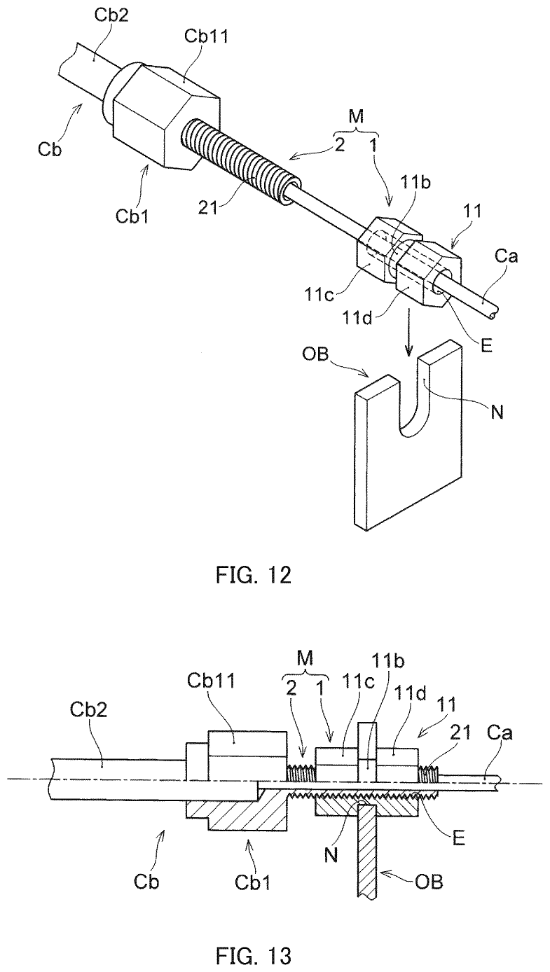

Next, a position adjustment mechanism in the third embodiment will be described with reference to FIGS. 12 to 14. As illustrated in FIGS. 12 and 13, position adjustment mechanism M of the present embodiment includes: engaging section 2 provided at end section Cb1 of outer casing Cb and including screw section 21; and position adjustment section 1 connected to engaging section 2 and configured to be capable of adjusting a relative position of outer casing Cb with respect to connection object OB to which end section Cb1 of outer casing Cb is connected.

Note that, regarding a detailed description of a configuration of engaging section 2 and position adjustment section 1, portions in which the configuration can be the same as those of the first and second embodiments are omitted, and a description will be made mainly of differences. All the matters described in the first and second embodiments with respect to engaging section 2 and position adjustment section 1 can be applied to position adjustment mechanism M in the third embodiment as far as the object of the present invention can be achieved, and the configuration of the present embodiment and the contents described in the first and second embodiments can be combined and used. Further, the effect obtained by the configuration described in the first and second embodiments can be obtained in the third embodiment as long as the first and second embodiments are included in the third embodiment.

The present embodiment is different from the first embodiment in that engaging section 2 is provided at outer casing Cb, and connection object OB is a part (a bracket in the present embodiment) to which end section Cb1 of outer casing Cb is connected. Note that, in FIGS. 12 and 13, only the structure of one end section of outer casing Cb, that is, the side of end section Cb1, is illustrated, but the engaging section may be provided at the other end section of outer casing Cb, and the position adjustment section to be attached to or fixed to the connection object may be provided at the side of the other end section. Further, in the present embodiment, connection object OB to which end section Cb1 of outer casing Cb is connected is illustrated as a plate-like bracket, but the structure of connection object OB is not particularly limited as long as position adjustment section 1 can be attached or fixed to connection object OB. Note that, in the present embodiment, position adjustment section 1 is attached to notch N provided in connection object OB, which is a bracket having a plate shape. Position adjustment section 1 includes attachment section 11b that can be attached to notch N of connection object OB. Attachment section 11b is, in the present embodiment, a groove provided between first cylindrical section 11c and second cylindrical section 11d of position adjustment section 1 (engaged body 11) to be described later. Attachment section 11b enters notch N, and the end wall of first cylindrical section 11c on the side of attachment section 11b and the end wall of second cylindrical section 11d on the side of attachment section 11b respectively engage with one surface and the other surface of connection object OB, thereby connecting position adjustment section 1 to connection object OB.

In the present embodiment, outer casing Cb includes outer casing main body Cb2, which is a cylindrical body having flexibility, and end section Cb1 of outer casing Cb, and a casing cap is connected to end section Cb1. As illustrated in FIGS. 12 and 13, the casing cap connected to one end section Cb1 of outer casing Cb includes engaging section 2 including screw section 21. Engaging section 2 engages with position adjustment section 1 so as to be capable of adjusting the position of the casing cap provided at one end section Cb1 of outer casing Cb in the axial direction. Engaging section 2 includes screw section 21 on the outer periphery thereof, and is configured to threadedly engage with position adjustment section 1. The shape and structure of engaging section 2 are not particularly limited as long as engaging section 2 can engage with position adjustment section 1 so as to be capable of adjusting a position of one end section Cb1 of outer casing Cb in the axial direction. In the present embodiment, engaging section 2 is formed, in a casing cap provided at end section Cb1 of outer casing Cb, in a substantially cylindrical shape in which screw section 21 formed as a male screw is included on the outer periphery, and has a space into which inner cable Ca is inserted. In the present embodiment, the casing cap provided at one end section Cb1 of outer casing Cb can be, for example, a cylindrical member made of a resin or metal. In the present embodiment, the casing cap provided at one end section Cb1 of outer casing Cb includes a cylindrical section to which one end section Cb1 of outer casing Cb is fixed, and engaging section 2 extends in the axial direction from the cylindrical section. In the present embodiment, cylindrical section Cb11 of the casing cap is formed in a nut shape, and, as described later, the position of position adjustment section 1 with respect to outer casing Cb can be adjusted by relatively rotating engaging section 2 and position adjustment section 1. Note that, the shape and structure of each component of the casing cap, such as the cylindrical section, are not limited to the illustrated structure.

As in the first embodiment, position adjustment section 1 includes engaged section E (see FIG. 13) that is shaved by screw section 21 and engaged with screw section 21 by the relative rotation of engaging section 2 and position adjustment section 1. Engaged section E is engaged with screw section 21 in a state where a part of engaged section E is shaved by screw section 21 and the screw groove is cut by screw section 21 by engaging section 2 and position adjustment section 1 relatively rotating. This causes the position of end section Cb1 of outer casing Cb in the axial direction to be adjusted depending on a direction and a rotation amount of the relative rotation between engaging section 2 and position adjustment section 1, and restricts the relative movement of end section Cb1 of outer casing Cb with respect to position adjustment section 1 in the axial direction. The relative rotation between engaging section 2 and position adjustment section 1 may be relative rotation caused by engaging section 2 rotating with respect to position adjustment section 1, relative rotation caused by position adjustment section 1 rotating with respect to engaging section 2, or relative rotation caused by both engaging section 2 and position adjustment section 1 rotating.

When engaging section 2 and position adjustment section 1 are relatively rotated while a part of screw section 21 of engaging section 2 is in contact with a part constituting engaged section E, the part constituting engaged section E is shaved into a screw groove by screw section 21. Thus, engaged section E and screw section 21 engage with each other (see FIG. 13). In a case where further position adjustment of end section Cb1 of outer casing Cb is necessary in this state, engaging section 2 and position adjustment section 1 are relatively rotated to a predetermined direction in the direction around the axis, thereby moving end section Cb1 of outer casing Cb with respect to position adjustment section 1 in the axial direction. Further, end section Cb1 of outer casing Cb is held in a predetermined position in the axial direction after movement for position adjustment by engagement between engaged section E and screw section 21. Thus, it is possible to adjust the position of end section Cb1 of outer casing Cb.

In the present embodiment, position adjustment mechanism M (position adjustment section 1) can adjust the position of end section Cb1 of outer casing Cb by causing engaging section 2 and position adjustment section 1 to relatively rotate to shave a part of engaged section E and by moving engaging section 2 with respect to position adjustment section 1 in the axial direction, without a structure such as an adjustment device that is provided at the middle of the outer casing and adjusts the length of the outer casing. Accordingly, in the present embodiment, position adjustment mechanism M, position adjustment section 1, and the entire device can be miniaturized, and which makes it possible for position adjustment mechanism M and position adjustment section 1 to be applied to an attachment object for which a sufficient installation space or workspace cannot be provided around the attachment object. Further, engaged section E is engaged with screw section 21 in a state of being in close contact with screw section 21 on both sides in the axial direction (preferably on both sides in the axial direction and in the radial direction) by being shaved by screw section 21. Thus, a gap is less likely to be generated between screw section 21 and engaged section E. Accordingly, as illustrated in FIG. 13, the friction increases due to the close contact between screw section 21 and engaged section E, which suppresses the loosening of screw section 21 with respect to engage section E caused by an external factor such as vibration of the attachment object such as a vehicle or the operation of inner cable Ca.

The shape and structure of position adjustment section 1 are not particularly limited as long as position adjustment section 1 includes engaged section E as described above, a part of engaged section E can be shaved by the relative rotation of engaging section 2 and position adjustment section 1, and the position of end section Cb1 of outer casing Cb can be adjusted by moving engaging section 2 with respect to position adjustment section 1 in the axial direction. The present embodiment is different from the first embodiment in that position adjustment section 1 does not include housing member 12 and is constituted by engaged body 11. Position adjustment section 1 constituted by engaged body 11 includes first cylindrical section 11c provided on one side in the axial direction, second cylindrical section 11d provided on the other side in the axial direction, and attachment section 11b provided between first cylindrical section 11c and second cylindrical section 11d, as illustrated in FIGS. 12 and 13. First cylindrical section 11c and second cylindrical section 11d project radially outward (a direction perpendicular to the axial direction) with respect to attachment section 11b. First cylindrical section 11c and second cylindrical section 11d each have, on the outer surface, an engaging structure engageable around the axis so that position adjustment section 1 can easily rotate around the axis. In the present embodiment, the engagement structure is nut-shaped (hexagonal nut), and is rotated in the direction around the axis with a wrench, thereby enabling position adjustment between position adjustment section 1 and engaging section 2 in the axial direction. Note that, the engagement structure is not limited to a nut shape, and may be, for example, a serration, or may be a dial shape in which recessed and protruding sections are alternately formed around the axis so as to be manually rotated, or may be another structure. Further, attachment section 11b is cylindrical in the present embodiment, and in this case, it is possible for position adjustment section 1 to relatively rotate with respect to connection object OB in a state of being connected to connection object OB. Thus, position adjustment can be performed while position adjustment section 1 is connected to connection object OB, which makes position adjustment easy.

In the present embodiment, first cylindrical section 11c and second cylindrical section 11d are integrated with each other by attachment section 11b provided between first cylindrical section 11c and second cylindrical section 11d, but first cylindrical section 11c and second cylindrical section 11d may be separate from each other. A mechanism may be applied in which first cylindrical section 11c or second cylindrical section 11d and engaging section 2 relatively rotate so that first cylindrical section 11c and second cylindrical section 11d come close to each other while connection object OB is positioned between first cylindrical section 11c and second cylindrical section 11d, and thus connection object OB is attached in an interposed manner to be fixed, so that position adjustment section 1 is connected to connection object OB.

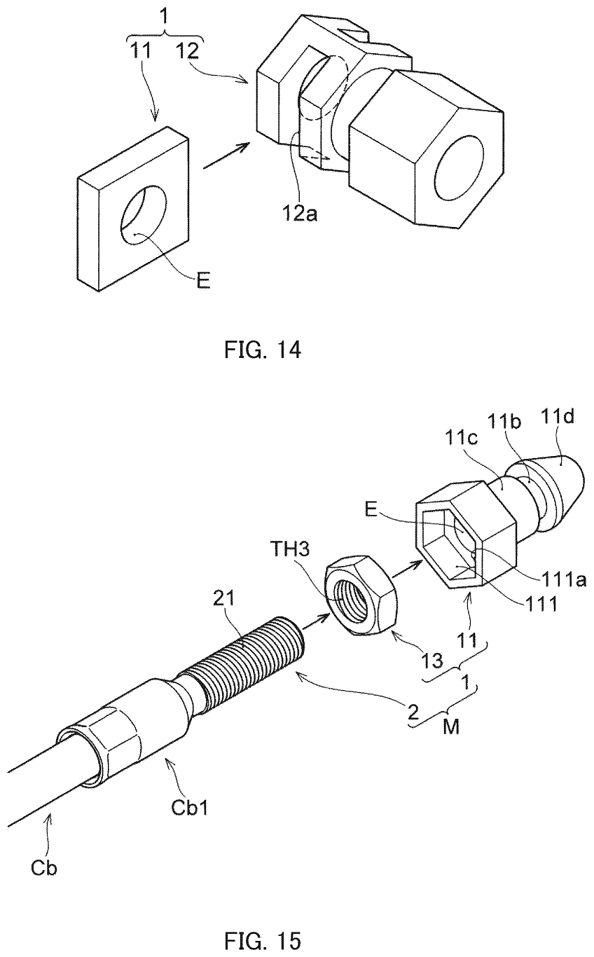

Further, as a variation of position adjustment section 1, position adjustment section 1 may be constituted by housing member 12 and engaged body 11 as illustrated in FIG. 14. In the present embodiment, the shape and the structure of housing member 12 are the same as those of engaged body 11 in FIGS. 12 and 13. However, housing member 12 is not particularly limited as long as housing member 12 can house engaged body 11, can cause engaging section 2 and position adjustment section 1 to relatively rotate to shave engaged section E when housing engaged body 11, and can adjust the position of end section of Cb1 of outer casing Cb by moving engaging section 2 with respect to position adjustment section 1 in the axial direction. Note that, the shape and the structure of engaged body 11 are not particularly limited, and engaged body 11 may have, in the same manner as in the engaged body of the first embodiment, a restricting section for preventing engaged body 11 inserted through opening section 12a from being detached from housing member 12.

Note that, as a method for connecting position adjustment section 1 to connection object OB, in addition to the method described in the present embodiment, a method in which position adjustment section 1 is attached or fixed to connection object OB by a magnetism, a snap-fit, or the like may be applied, and the method for connecting position adjustment section 1 to connection object OB is not particularly limited as long as position adjustment section 1 can be connected to connection object OB. Further, in the present embodiment, position adjustment mechanism M is provided on the side of end section Cb1 of outer casing Cb, but may be provided on both of the side of end section Ca1 side of inner cable Ca and the side of end section Cb of outer casing Cb.

Next, a position adjustment mechanism in the fourth embodiment will be described with reference to FIGS. 15 to 17. As illustrated in FIGS. 15 to 17, position adjustment mechanism M of the present embodiment includes: engaging section 2 provided at end section Cb1 of outer casing Cb and including screw section 21; and position adjustment section 1 connected to engaging section 2 and configured to be capable of adjusting the relative position of outer casing Cb with respect to connection object OB (see FIG. 12) to which end section Cb1 of outer casing Cb is connected.

Note that, regarding configurations of engaging section 2 and position adjustment section 1, a detailed description of portions in which the configuration can be the same as those of the first to third embodiments are omitted, and a description will be made mainly of differences. All the matters described in the first to third embodiments with respect to engaging section 2 and position adjustment section 1 can be applied to position adjustment mechanism M in the fourth embodiment as far as the object of the present invention can be achieved, and the configuration of the present embodiment and the contents described in the first to third embodiments can be combined and used. Further, the effect obtained by the configuration described in the first to third embodiments can be obtained in the fourth embodiment as long as the fourth embodiment has the configuration.

In the present embodiment, position adjustment section 1 is attached to notch N provided in connection object OB, which is a bracket having a plate shape (see FIG. 12). Position adjustment section 1 includes attachment section 11b that can be attached to notch N of the connection object OB. Attachment section 11b is, in the present embodiment, a groove provided between first cylindrical section 11c and second cylindrical section 11d.

Engaging section 2 includes screw section 21 on the outer periphery thereof, and is configured to threadedly engage with position adjustment section 1. In the present embodiment, a casing cap provided at one end section Cb1 of outer casing Cb includes a cylindrical section to which one end section Cb1 of outer casing Cb is fixed, and engaging section 2 extends in the axial direction from the cylindrical section.

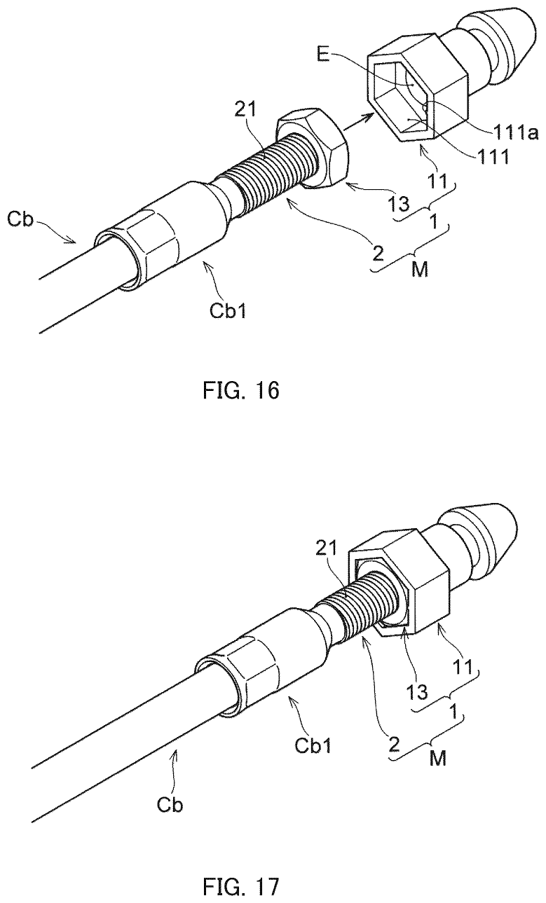

As illustrated in FIGS. 15 and 16, position adjustment section 1 includes engaged body 11 provided with engaged section E and fitting member 13 fitted into engaged body 11. Engaged body 11 includes housing section 111 into which fitting member 13 is fitted and housed, and fitting member 13 includes fitting member screw section TH3 with which screw section 21 engages. In the present embodiment, when screw section 21 of engaging section 2 shaves engaged section E of engaged body 11, screw section 21 of engaging section 2 engages with fitting member screw section TH3 of fitting member 13 fitted into housing section 111 of engaged body 11, and moves in the axial direction. Thus, screw section 13 moves in the axial direction while the axial center of screw section 21 at the time when screw 21 shaves engaged section E is aligned with the axial center of engaged section E, and shaves engaged section E. This prevents insertion of engaging section 2 into engaged body 11 in a state of being inclined with respect to engaged body 11, and prevents shaving of engaged body 11 at an abnormal angle.

Fitting member 13 is configured to be fitted to engaged body 11 and to threadedly engage with screw section 21. In the present embodiment, fitting member 13 is fitted to the engaged body so as to co-rotate with engaged body 11, and is configured to be fitted to the inner surface of housing section 111 around the axis of screw section 21. In the present embodiment, fitting member 13 has a hexagonal nut shape, but is not limited thereto as long as fitting member 13 is configured to co-rotate with engaged body 11. For example, the outer shape of the fitting member may be a polygon other than a hexagon, such as a rectangle, or may have a structure in which one or a plurality of projections that extend in the axial direction are provided on the outer surface. Note that, housing section 111 of engaged body 11 in which fitting member 13 is housed has a shape corresponding to the shape of fitting member 13. In the present embodiment, housing section 111 includes protruding section 111a on the inner surface facing the outer surface of fitting member 13 to prevent play between fitting member 13 and housing section 111. Protruding section 111a may be a projection that extends in the axial direction on the inner surface of housing section 111 or may be a point-like protrusion. Further, a plurality of protruding sections 111a may be provided on the inner surface of housing section 111. Note that, as long as fitting member 13 is fitted to engaged body 11 so as to co-rotate with engaged body 11, engaged body 11 need not include housing section 111.

An example of the way to perform the position adjustment in position adjustment mechanism M in the present embodiment will be described below. Note that, the following description is merely an example, and the present invention is not limited by the description. Each procedure described in the following may be performed in a changed order.

First, as illustrated in FIGS. 15 and 16, fitting member 13 is threadedly engaged with screw section 21 of engaging section 2 at the leading end. In that state, engaging section 2 with which fitting member 13 has been threadedly engaged is moved in the axial direction such that fitting member 13 is fitted into housing section 111. As illustrated in FIG. 17, engaged body 11 and engaging section 2 are relatively rotated while fitting member 13 is fitted into housing section 111. Screw section 21 is moved in the axial direction while the axial center of screw section 21 coincides with the axial center of engaged section E of engaged body 11 by fitting member 13, and shaves engaged section E. Thus, as described above, the insertion of engaging section 2 in a state of being inclined with respect to engaged body 11 is prevented, and engaged body 11 is prevented from being shaved at an abnormal angle. Position adjustment mechanism M is connected to connection object OB in a state in which engaged section E is shaved by screw section 21, and engaged body 11 and engaging section 2 are connected to each other. In a case where further position adjustment is necessary, relatively rotating engaged body 11 and engaging 2 causes engaging section 2 to move with respect to engaged body 11 in the axial direction, and then the relative position of the outer casing with respect to connection object OB can be adjusted.

Note that, in the above-described example, fitting member 13 is housed in housing section 111 in a state where fitting member 13 threadedly engages with screw section 21, but fitting member 13 may be first housed in housing section 111 without threadedly engaging with screw section 21, and screw section 21 may be threadedly engaged with fitting member 13 that is in a state of being housed in housing section 111.

Although the embodiments of the present invention have been described above, the present invention is not limited to the above embodiments. The above-described embodiments mainly describe an invention having the following configuration.

(1) A position adjustment mechanism, including:
an engaging section that is provided at an end section of an inner cable and includes a screw section; and
a position adjustment section to which the end section of the inner cable is connected and which is attached or fixed to a connection object, in which
the position adjustment section includes an engaged section shaved by the screw section and engaged with the screw section by relative rotation of the engaging section and the position adjustment section.

(2) The position adjustment mechanism according to (1), in which the position adjustment section includes an engaged body provided with the engaged section, and a housing member housing the engaged body.

(3) The position adjustment mechanism according to (1) or (2), in which the position adjustment section includes an opening section into which the engaged body is insertable perpendicularly to an axis of the inner cable.

(4) The position adjustment mechanism according to any one of (1) to (3), in which the housing member includes a detachment prevention section, the detachment prevention section being deformable such that a width of the opening section is narrowed to be a width at which the engaged body is not detachable from the opening section while the engaged body is inserted into the housing member from the opening section.

(5) The position adjustment mechanism according to any one of (1) to (4), in which the engaged body includes a restricting section that restricts movement of the engaged body in a direction in which the engaged body is detached from the opening section.

(6) The position adjustment mechanism according to any one of (1) to (5), in which the housing member includes an insertion section provided at a position at which the engaging section is capable of being guided to the engaged section, and the insertion section includes a housing member screw section formed to be engaged with the screw section of the engaging section.

(7) The position adjustment mechanism according to any one of (1) to (6), in which the engaged section is made of a resin.

(8) The position adjustment mechanism according to any one of (1) to (7), in which the engaged body further includes, in addition to the engaged section, an engaged body screw section provided to be engaged with the screw section of the engaging section, and the engaged body screw section is made of a predetermined rigid material having a rigidity higher than a rigidity of the engaged section.

(9) The position adjustment mechanism according to any one of (1) to (8), in which the engaged body is a cylindrical body including a through-hole into which the engaging section is inserted,
the engaged body includes a first end section and a second end section, the first end section being on a side into which the engaging section is first inserted in an axial direction, the second end section being on a side opposite to the first end section, and
the engaged section is made of an annular resin material provided on a side of the second end section on an inner surface of the engaged body, and the engaged body screw section is a female screw made of a metal material and provided on the inner surface of the engaged body to be adjacent to the engaged section in the axial direction.

(10) A position adjustment mechanism, including:
an engaging section that is provided at an end section of an outer casing and includes a screw section; and
a position adjustment section that is connected to the engaging section and is provided to be capable of adjusting a relative position of the outer casing with respect to a connection object to which the end section of the outer casing is connected, in which
the position adjustment section includes an engaged section shaved by the screw section and engaged with the screw section by relative rotation of the engaging section and the position adjustment section.

(11) The position adjustment mechanism according to (10), in which
the position adjustment section includes an engaged body provided with the engaged section and a fitting member fitted to the engaged body, and the fitting member is fitted to the engaged body so as to co-rotate with the engaged body and includes a fitting member screw section engaged with the screw section.

(12) The position adjustment mechanism according to (10), in which
the position adjustment section includes an engaged body provided with the engaged section and a fitting member fitted to the engaged body, the engaged body includes a housing section in which the fitting member is fitted and housed, and the fitting member includes a fitting member screw section engaged with the screw section.

(13) A position adjustment member to which an end section of an outer casing including an engaging section including a screw section or an end section of an inner cable including an engaging section including a screw section is connected and which is attached or fixed to a connection object, the position adjustment member including:

an engaged section that is engaged with the screw section by being shaved by the screw section by relative rotation of the engaging section and the position adjustment member.

### REFERENCE SIGNS LIST

1 Position adjustment section
11 Engaged body
11a Restricting section
11b Attachment section
11c First cylindrical section
11d Second cylindrical section
11e Engaged body screw section
11f First end section
11g Second end section
111 Housing section
111a Protruding section
12 Housing member
12a Opening section
12b Detachment prevention section
12c Step-shaped portion
121 Housing section
122 Attachment section
13 Fitting member
2 Engaging section
21 Screw section
22 Taper section
C Control cable
Ca Inner cable
Ca1 Inner cable one end section
Ca2 Inner cable other end section
Ca3 Cable main body
Cb Outer casing
Cb1 Outer casing end section
Cb11 Cylindrical section
Cb2 Outer casing main body
D Cable operation device
E Engaged section
H Through-hole
IS Insertion section
IS2 Second insertion section
M Position adjustment mechanism
N Notch
OB Connection object
OB2 Second connection object
TH, TH2 Housing member screw section
TH3 Fitting member screw section
W1 First wall section
W2 Second wall section
W3 Side wall

1. A position adjustment mechanism, comprising:
an engaging section that is provided at an end section of an inner cable and includes a screw section; and
a position adjustment section to which the end section of the inner cable is connected and which is attached or fixed to a connection object, wherein
the position adjustment section includes an engaged section shaved by the screw section and engaged with the screw section by relative rotation of the engaging section and the position adjustment section.

2. The position adjustment mechanism according to claim 1, wherein
the position adjustment section includes an engaged body provided with the engaged section, and a housing member housing the engaged body.

3. The position adjustment mechanism according to claim 2, wherein
the housing member includes an opening section through which the engaged body is insertable in a direction perpendicular to an axis of the inner cable.

4. The position adjustment mechanism according to claim 3, wherein
the housing member includes a detachment prevention section, the detachment prevention section being deformable such that a width of the opening section is narrowed to be a width at which the engaged body is not detachable from the opening section while the engaged body is inserted into the housing member from the opening section.

5. The position adjustment mechanism according to claim 3, wherein
the engaged body includes a restricting section that restricts movement of the engaged body in a direction in which the engaged body is detached from the opening section.

6. The position adjustment mechanism according to claim 2, wherein
the housing member includes an insertion section provided at a position at which the engaging section is capable of being guided to the engaged section, and
the insertion section includes a housing member screw section formed to be engaged with the screw section of the engaging section.

7. The position adjustment mechanism according to claim 1, wherein
the engaged section is made of a resin.

8. The position adjustment mechanism according to claim 2, wherein
the engaged body further includes, in addition to the engaged section, an engaged body screw section provided to be engaged with the screw section of the engaging section, and the engaged body screw section is made of a predetermined rigid material having a rigidity higher than a rigidity of the engaged section.

9. The position adjustment mechanism according to claim 8, wherein
the engaged body is a cylindrical body including a through-hole into which the engaging section is inserted,
the engaged body includes a first end section and a second end section, the first end section being on a side into which the engaging section is first inserted in an axial direction, the second end section being on a side opposite to the first end section, and
the engaged section is made of an annular resin material provided on a side of the second end section on an inner surface of the engaged body, and the engaged body screw section is a female screw made of a metal material and provided on the inner surface of the engaged body to be adjacent to the engaged section in the axial direction.

10. A position adjustment mechanism, comprising:
an engaging section that is provided at an end section of an outer casing and includes a screw section; and
a position adjustment section connected to the engaging section and provided to be capable of adjusting a relative position of the outer casing with respect to a connection object to which the end section of the outer casing is connected, wherein
the position adjustment section includes an engaged section shaved by the screw section and engaged with the screw section by relative rotation of the engaging section and the position adjustment section.

11. The position adjustment mechanism according to claim 10, wherein
the position adjustment section includes an engaged body provided with the engaged section and a fitting member fitted to the engaged body, and the fitting member is fitted to the engaged body so as to co-rotate with the engaged body and includes a fitting member screw section engaged with the screw section.

12. The position adjustment mechanism according to claim 10, wherein
the position adjustment section includes an engaged body provided with the engaged section and a fitting member fitted to the engaged body, the engaged body includes a housing section in which the fitting member is fitted and housed, and the fitting member includes a fitting member screw section engaged with the screw section.

13. A position adjustment member to which an end section of an outer casing including an engaging section including a screw section or an end section of an inner cable including an engaging section including a screw section is connected and which is attached or fixed to a connection object, the position adjustment member comprising:
an engaged section that is engaged with the screw section by being shaved by the screw section by relative rotation of the engaging section and the position adjustment member.
